(19) United States
(12) Patent Application Publication
(10) Pub. No.: US 2023/0312806 A1
(43) Pub. Date: Oct. 5, 2023

(54) ISOCYANATE COMPOUNDS AND ADHESIVE COMPOSITIONS COMPRISING THE SAME

(71) Applicants: Dow Global Technologies LLC, Midland, MI (US); Rohm and Haas Company, Collegeville, PA (US)

(72) Inventors: Rui Shi, Shanghai (CN); Gaobing Chen, Shanghai (CN); Zhaohui Qu, Shanghai (CN)

(21) Appl. No.: 18/041,445

(22) PCT Filed: Oct. 22, 2020
(86) PCT No.: PCT/CN2020/122735

§ 371 Date: Feb. 13, 2023

(51) Int. Cl. C08G 18/38; C09J 175/06; C09J 7/30

(52) U.S. Cl. CPC C08G 18/3885; C09J 175/06; C09J 7/30

(57) ABSTRACT

An isocyanate compound containing a phosphate functional group obtainable or obtained by the reaction of at least one selected from the group consisting of an isocyanate monomer, an isocyanate adduct and combinations thereof, with a phosphate functional polyol is provided. Also provided are an adhesive composition comprising the isocyanate compound, cured adhesive compositions, methods of producing cured laminates, the so produced cured laminates and use of the isocyanate compound in a two-component solvent-based adhesive composition.

### FIELD OF THE DISCLOSURE

The present disclosure relates to isocyanate compounds. More particularly, the present disclosure relates to phosphate functional isocyanate compounds, adhesive compositions comprising the same, articles prepared from the adhesive compositions and methods of manufacture thereof. The phosphate functional isocyanate compounds provide an adhesive composition with improved performances in terms of, for example, one or more of bonding strength, heat seal performance and chemical resistance.

### BACKGROUND

Adhesive compositions are useful for a wide variety of purposes. For instance, adhesive compositions are used to bond together substrates such as polyethylenes, polypropylenes, polyesters, polyamides, metals, papers, or cellophanes to form composite films, i.e., laminates. The use of adhesives in different laminating end-use applications is generally known. For example, adhesives can be used in the manufacture of film/film and film/foil laminates used in the packaging industry, especially for food packaging. Adhesives used in laminating applications, or “laminating adhesives,” can be generally placed into three categories: solvent-based, water-based, and solventless. The performance of an adhesive varies by category and by the application in which the adhesive is applied.

Within the category of solvent-based laminating adhesives, there are many varieties. One particular variety includes two-component polyurethane-based laminating adhesives. Typically, a two-component polyurethane-based laminating adhesive includes a first component comprising an isocyanate and/or a polyurethane prepolymer and a second component comprising one or more polyols. The two components are combined, thereby forming an adhesive composition. The adhesive composition, carried in a solvent, is then applied on a substrate such as a film/foil substrate. The solvent is evaporated from the applied adhesive composition. Another film/foil substrate is then brought into contact with the other substrate, forming a curable laminate structure. The laminate structure is cured to bond the two substrates together.

However, most of the current two-component solvent based lamination adhesives have been found to fail in boiling in bag (BIB) test with Morton soup, and are not suitable for use in applications such as food package applications with typical foil based structure of Foil/PE and Foil/RCPP. It is therefore desirable to develop a two-component solvent based adhesive with improved performances in terms of, for example, one or more of bonding strength, chemical resistance and heat resistance, for foil based lamination structures.

### SUMMARY OF THE DISCLOSURE

In an aspect, the present disclosure provides an isocyanate compound containing a phosphate functional group, obtainable or obtained by the reaction of at least one selected from the group consisting of an isocyanate monomer, an isocyanate adduct and combinations thereof, with a phosphate functional polyol.

In a further aspect, the present disclosure provides an adhesive composition, comprising:
(A) an isocyanate component comprising an isocyanate prepolymer which comprises the isocyanate compound as described herein; and
(B) a polyol component comprising at least one polyester polyol.

In a further aspect, the present disclosure provides a cured adhesive composition prepared from the adhesive composition as described herein, comprising the reaction product of a curable mixture of the polyol component and the isocyanate component of the adhesive composition.

In a further aspect, the present disclosure provides a method of producing a cured laminate by using the adhesive composition as described herein, comprising,
(a) providing the adhesive composition comprising an isocyanate component and a polyol component;
(b) bringing the isocyanate component and the polyol component into contact, to form a curable mixture;
(c) applying the curable mixture on a first portion of a surface of a substrate to form a layer of the curable mixture;
(d) bringing a second portion of a surface of the same substrate or a different substrate into contact with the layer of the curable mixture, so that the layer of the curable mixture is sandwiched between the first portion and the second portion;
(e) evaporating the solvent or allowing it to evaporate; and
(f) curing the curable mixture or allowing it to cure.

In a further aspect, the present disclosure provides a cured laminate prepared by using the method as described above.

In a further aspect, the present disclosure provides a cured laminate comprising a first portion of a surface of a substrate, a layer of a cured adhesive composition as described herein, and a second portion of a surface of the same substrate or a different substrate, wherein the layer of the cured adhesive composition is sandwiched between and in contact with the first portion and the second portion.

In a further aspect, the present disclosure provides use of the isocyanate compound as described herein in a two-component solvent-based adhesive composition.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. As disclosed herein, all percentages mentioned herein are by weight, and temperatures in ° C., unless specified otherwise.

Isocyanate Compound

Provided herein is an isocyanate compound containing a phosphate functional group, also referred herein as a phosphate functional isocyanate compound.

In some embodiments, the phosphate functional isocyanate compound of the present disclosure can be obtainable or obtained by the reaction of at least one selected from the group consisting of an isocyanate monomer, an isocyanate adduct and combinations thereof, with a phosphate functional polyol.

In some embodiments, the phosphate functional isocyanate compound can be obtainable or obtained by the reaction of at least one selected from the group consisting of an isocyanate monomer, an isocyanate adduct and combinations thereof, with a phosphate functional polyol, in a solvent.

In some embodiments, the phosphate functional polyol can be a phosphate ester polyol. In some embodiments, the phosphate functional polyol can have the structure represented by Formula (I):

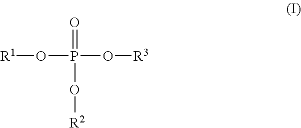

wherein each of R¹, R² and R³ independently represents hydrogen or an organic group, with the proviso that at least one of R² and R³ represents an organic group, and R¹, R² and R³ altogether comprise at least two hydroxyl groups.

As used herein, the term “organic group” refers to any group comprising at least one carbon-carbon bond and/or carbon-hydrogen bond. In some embodiments of Formula (I), the organic group can be any organic group. Examples of the suitable organic groups can include, but not limited to, an alkyl-containing group, an alkenyl-containing group, a cycloalkyl-containing group, an aryl-containing group, an alkoxy-containing group, an ester-containing group, an ether-containing group, a polyester-containing group, a polyether-containing group, and the combinations thereof.

In some embodiments, the at least two hydroxyl groups comprised in R¹, R² and R³ are preferably primary hydroxyl groups. As used herein, the term “primary hydroxyl” refers to a hydroxyl group (—OH) on a carbon atom which has only one other carbon atom attached to it, (preferably which, in addition to the optional single carbon atom, has only hydrogen atoms attached thereto).

In some embodiments of Formula (I), one of R¹, R² and R³ represents an organic group and comprises at least two hydroxyl groups (e.g., primary hydroxyl groups). In some embodiments, two of R¹, R² and R³ represent each independently an organic group and comprise altogether at least two hydroxyl groups (e.g., primary hydroxyl groups). In some embodiments, R² and R³ represent each independently an organic group and comprise altogether at least two hydroxyl groups (e.g., primary hydroxyl groups).

As used herein, an “isocyanate monomer” is any compound that contains two or more isocyanate groups. An “aromatic isocyanate” is an isocyanate that contains one or more aromatic rings. An “aliphatic isocyanate” contains no aromatic rings.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure include, but are not limited to, isomers of methylene diphenyl dipolyisocyanate (“MDI”) such as 4,4-MDI, 2,4-MDI and 2,2′-MDI, or modified MDI such as carbodiimide modified MDI or allophanate modified MIDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure include, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprise diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

As used herein, an “isocyanate adduct” can be a polyisocyanate adduct prepared by reacting excess quantities of isocyanate (such as aromatic diisocyanate) with low molecular weight glycols and polyols having molecular weight less than 400. Suitable examples of the glycols and polyols having molecular weight less than 400 include, but are not limited to, diethylene glycol, ethylene glycol, triethylene glycol, 1,3-propanediol, 1,3-butanediol, 1,4-butanediol, 1,6-hexanediol, and neopentyl glycol, trimethylpropane (TMP), glycerol, and pentaerythrotol. In some embodiments, the isocyanate adduct can comprise two or more isocyanate groups.

In some embodiments, the solvent can be an organic solvent. Common organic solvents used in such systems include methyl ethyl ketone, ethyl acetate, toluene and the like, all of which must be moisture-free to prevent premature reaction of the isocyanate groups of the polyurethane. In some embodiments, the solvent can be selected from the group consisting of methyl ethyl ketone, ethyl acetate, toluene and the combinations thereof.

In some embodiments, the at least one selected from the group consisting of an isocyanate monomer, an isocyanate adduct and combinations thereof is reacted in an excess amount with the phosphate functional polyol. In some embodiments, the weight ratio between the at least one selected from the group consisting of an isocyanate monomer, an isocyanate adduct and combinations thereof and the phosphate functional polyol in the reaction can be in the range of, for example, from 1:1 to 20:1, from 1.2:1 to 18:1, or from 1.5:1 to 15:1.

In some embodiments, the phosphate functional isocyanate compound according to the present disclosure can be a phosphate ester (for example, a phosphate monoester, or a phosphate diester, a phosphate triester) having at least one, or at least two, or three terminal isocyanate groups.

Adhesive Composition

The adhesive composition according to the present disclosure comprises (A) an isocynate component and (B) a polyol component.

In some embodiments, the adhesive composition according to the present disclosure can be a two-component adhesive composition. In some embodiments, the adhesive composition according to the present disclosure can be solvent based.

As used herein, the term “two-component” means that the adhesive composition is provided in parts separated from each other before use. Typically, the composition according to the present disclosure includes at least a first component comprising an isocyanate-containing prepolymer (also referred to herein as an “isocyanate component” or “NCO component”) and a second component comprising one or more polyols (also referred to herein as a “polyol component” or “OH component”). In an illustrative embodiment of the present disclosure, the isocyanate component and the polyol component are prepared, stored, transported and served separately, combined shortly or immediately before being applied, for example, to a surface of a substrate.

It is contemplated that the isocyanate component and the polyol component of the adhesive composition as described herein can be made separately and, if desired, stored separately until it is desired to use the adhesive composition. When it is desired to use the adhesive composition, the isocyanate component and the polyol component are brought into contact with each other and mixed together. It is contemplated that when these two components are brought into contact, a curing reaction begins in which the isocyanate groups react with the hydroxyl groups to form urethane links. The adhesive composition formed by bringing the two components into contact can be referred to as a “curable mixture.”

In various embodiments of the present disclosure, the isocyanate component can comprise an isocyanate prepolymer. The isocyanate prepolymer can comprise the reaction product of at least one isocyanate monomer, at least one polyol selected from the group consisting of a polyester polyol, a polyether polyol and the combination thereof. In some embodiments, the isocyanate prepolymer can comprise the phosphate functional isocyanate compound of the present disclosure as described above.

In various embodiments of the present disclosure, the polyol component can comprise at least one polyol selected from the group consisting of a polyester polyol, a polyether polyol, and the combination thereof. In some embodiments, the polyol component can comprise one or more polyester polyols. In some embodiments, the polyol component can be substantially free of, or comprises only non-effective amounts of, or be free of a polyether polyol.

As used herein, the term “substantially free of” refers to an amount of a material that is less than 1%, 0.5%, 0.25%, 0.1%, 0.05%, 0.01%, or 0.001% by weight of a component, a composition or an article. “Free of” refers to no detectable amount of the stated material or ingredient.

In some embodiments, the adhesive composition according to the present disclosure further comprises a solvent. In some embodiments, the solvent can be present in one or both of the polyol component and the isocyanate component. In some embodiments, the solvent can be an organic solvent. Common organic solvents suitable for use in the polyol component can include methyl ethyl ketone, ethyl acetate, toluene and the like.

In some embodiments, the adhesive composition according to the present disclosure does not comprise highly-reactive amine-initiated polyol and phosphate ester polyol.

In some embodiments, the NCO group and OH group mix mole ratio in the adhesive composition can be, for example, more than 1:1, more than 1.2:1, more than 1.6:1, more than 1.8:1, or more than 2:1.

In some embodiments, the dry weight mix ratio of the polyol component to the isocyanate component in the adhesive composition according to the present disclosure can be within the numerical range obtained by combining any two of the following end points: 100:150, 100:140, 100:130, 100:120, 100:110, 100:100, 100:90, 100:80, 100:70, 100:60, 100:50, 100:40, 100:30, 100:25, 100:20, 100:15, 100:10, and 100:5. In some embodiments, the dry weight mix ratio of the polyol component to the isocyanate component in the adhesive composition according to the present disclosure can be within the range of from 100:150 to 100:5, for example, from 100:150 to 100:10, from 100:150 to 100:15.

In some embodiments, the adhesive composition of the present disclosure can be a polyurethane-based adhesive composition. In some embodiments, the adhesive composition of the present disclosure can be a laminating adhesive composition.

In some embodiments, the adhesive composition can, optionally, comprise one or more additional auxiliary agents and/or additives for specific purposes.

In some embodiments, the adhesive composition can, optionally, comprise one or more adhesion promoters to improve bond strength. Examples of the one or more adhesion promoters suitable for use in the adhesive composition include, but are not limited to, silane, epoxy and phenolic resin.

In further embodiments, the adhesive composition can, optionally, comprise one or more chain extenders. Examples of the one or more chain extenders suitable for use in the adhesive composition include, but are not limited to, glycerin, trimethylol propane, diethylene glycol, propanediol, and 2-methyl-1,3-propanediol.

In still further embodiments, the adhesive composition can, optionally, comprises one or more catalysts. Examples of the at least one catalyst suitable for use in the adhesive composition include, but are not limited to, dibutyltin dilaurate, zinc acetate, 2,2-dimorpholinodiethylether, and combinations thereof.

In some embodiments, the adhesive composition can further comprise one or more auxiliary agents and/or additives selected from the group consisting of other co-catalysts, surfactants, toughening agents, flow modifiers, diluents, stabilizers, plasticizers, catalyst de-activators, dispersing agents, colorants, and mixtures thereof.

In some embodiments, the adhesive composition does not comprise or is free of a colorant, for example, a pigment, a dye, or mixture thereof.

Polyol Component

The polyol component comprised in the adhesive composition according to the present disclosure can comprise at least one polyol and optionally a solvent.

In some embodiments, the polyol component comprised in the adhesive composition can comprise two or more polyols. In general, the polyol can be selected from the group consisting of a polyester polyol, a polyether polyol, and the combination thereof.

As used herein, the term “polyol” refers to a compound with two or more hydroxyl groups. A polyol with exactly two hydroxyl groups is a “diol.” A polyol with exactly three hydroxyl groups is a “triol.” A polyol with exactly four hydroxyl groups is a “tetraol.”

A compound that contains two or more ester linkages in the same linear chain of atoms is known herein as a “polyester.” A compound that is a polyester and a polyol is known herein as a “polyester polyol.” In some embodiments, the polyester polyols can have a molecular weight not to exceed 10,000 g/mol. In some embodiments, the polyester polyols can have a hydroxyl group functionality of at least 1.5 (i.e., f≥1.5).

Polyester polyols suitable for use according to this disclosure include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols include, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1,6-hexanediol, and neopentyl glycol. In order to achieve a polyester polyol functionality greater than 2, polyols having a functionality of 3 can optionally be included in the adhesive composition (e.g., trimethylolpropane, glycerol, erythritol, pentaerythritol, trimethylolbenzene or trishydroxyethyl isocyanurate).

Suitable dicarboxylic acids include, but are not limited to, aliphatic acids, aromatic acids, and combinations thereof. Examples of suitable aromatic acids include phthalic acid, isophthalic acid, terephthalic acid, and tetrahydrophthalic acid. Examples of suitable aliphatic acids include hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also includes any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

In some embodiments, the polyol component can comprise one or more polyester polyols.

In some embodiments, for example, the amount of the polyester polyol in the polyol component can be, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, or at least 85 wt %, based on the weight of the polyol component.

In some embodiments, the amount of polyol(s) in the adhesive composition can be at least 20 wt %, at least 25 wt %, at least 30 wt %, at least 35 wt %, at least 40 wt %, or at least 45 wt % based on the weight of the adhesive composition. In some embodiments, the amount of polyol(s) in the adhesive composition can be at most 70 wt %, at most 60 wt %, at most 55 wt %, or at most 50 wt %, based on the weight of the adhesive composition.

In some embodiments, the amount of polyester polyol(s) in the adhesive composition can be at least 20 wt %, at least 25 wt %, at least 30 wt %, at least 35 wt %, at least 40 wt %, or at least 45 wt % based on the weight of the adhesive composition. In some embodiments, the amount of the polyester polyol(s) in the adhesive composition can be at most 70 wt %, at most 60 wt %, at most 55 wt %, or at most 50 wt %, based on the weight of the adhesive composition.

There is no special limitation of the average molecular weight of polyol applied in the adhesive composition according to the present disclosure. In an embodiment of the present disclosure, the polyester polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

There is no special limitation of the average functionality of polyol applied in the adhesive composition according to the present disclosure.

In some embodiments, the polyol component can be substantially free of, or comprises only non-effective amounts of, or be free of a polyether polyol.

A compound that contains two or more ether linkages in the same linear chain of atoms is known herein as a “polyether.” A compound that is a polyether and a polyol is a “polyether polyol.” In some embodiments, the polyether polyols can have a molecular weight not to exceed 10,000 g/mol. In some embodiments, the polyether polyols can have a hydroxyl group functionality of at least 1.5 (i.e., f≥1.5).

In some embodiments, the polyol component can be substantially free of, or comprises only non-effective amounts of, or be free of a phosphate functional polyol, for example, the phosphate functional polyol as described above.

As used herein, the term “solvent” refers to organic and inorganic liquids whose function is solely dissolving one or more solid, liquid or gaseous materials without incurring any chemical reaction. The solvent used in the polyol component can be any solvent suitable for dissolving one or more materials comprised in the component without incurring any chemical reaction. In some embodiments, the solvent can be an organic solvent. Common organic solvents suitable for use in the polyol component can include methyl ethyl ketone, ethyl acetate, toluene and the like, all of which must be moisture-free to prevent premature reaction of the isocyanate groups of the polyurethane.

There is no special limitation of the amount of the solvent in the polyol component. In some embodiments, for example, the amount of a solvent in the polyol component can be, by weight based on the weight of the polyol component, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, or at least 75 wt %.

The polyol component can, optionally, comprise one or more additional auxiliary agents and/or additives for specific purposes.

In some embodiments, the polyol component can, optionally, comprise one or more adhesion promoters to improve bond strength. Examples of the one or more adhesion promoters suitable for use in the polyol component include, but are not limited to, silane, epoxy and phenolic resin.

In further embodiments, the polyol component can, optionally, comprise one or more chain extenders. Examples of the one or more chain extenders suitable for use in the polyol component include, but are not limited to, glycerin, trimethylol propane, diethylene glycol, propanediol, and 2-methyl-1,3-propanediol.

In still further embodiments, the polyol component can, optionally, comprises one or more catalysts. Examples of the at least one catalyst suitable for use in the polyol component include, but are not limited to, dibutyltin dilaurate, zinc acetate, 2,2-dimorpholinodiethylether, and combinations thereof.

In some embodiments, the polyol component can further comprise one or more auxiliary agents and/or additives selected from the group consisting of other co-catalysts, surfactants, toughening agents, flow modifiers, diluents, stabilizers, plasticizers, catalyst de-activators, dispersing agents and mixtures thereof.

Isocyanate Component

The isocyanate component comprised in the adhesive composition according to the present disclosure can comprise an isocyanate prepolymer and optionally a solvent.

In some embodiments, the isocyanate prepolymer can comprise the product obtainable or obtained by the reaction of at least one selected from the group consisting of an isocyanate monomer, an isocyanate adduct and combinations thereof, with a phosphate functional polyol, in a solvent.

In some embodiments, the isocyanate prepolymer can comprise the phosphate functional isocyanate compound as described herein. When comprised in the adhesive composition according to the present disclosure, the phosphate functional isocyanate compound can also be referred to as a “phosphate functional isocyanate hardener”.

In some embodiments, there is no special limitation of the amount of the phosphate functional isocyanate compound in the isocyanate component. In some embodiments, for example, the amount of the isocyanate prepolymer in the isocyanate component can be, by weight based on the weight of the isocyanate component, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 80 wt %, or at least 90 wt %.

In some embodiments, the amount of the isocyanate prepolymer in the adhesive composition as described can be at least 1 wt %, at least 3 wt %, at least 5 wt %, at least 8 wt %, at least 10 wt %, at least 11 wt %, or at least 12 wt %, based on the weight of the adhesive composition. In some embodiments, the amount of the isocyanate prepolymer in the adhesive composition as described can be at most 40 wt %, at most 30 wt %, at most 25 wt %, at most 20 wt %, at most 18 wt %, at most 17 wt % or at most 16 wt %, based on the weight of the adhesive composition.

In some embodiments, the amount of the phosphate functional isocyanate prepolymer in the adhesive composition can be at least 1 wt %, at least 3 wt %, at least 5 wt %, at least 8 wt %, at least 10 wt %, at least 11 wt %, or at least 12 wt %, based on the weight of the adhesive composition. In some embodiments, the phosphate functional isocyanate prepolymer can comprise at most 40 wt %, at most 30 wt %, at most 25 wt %, at most 20 wt %, at most 18 wt %, at most 17 wt % or at most 16 wt %, based on the weight of the adhesive composition.

In some embodiments, the isocyanate prepolymer can comprise the product obtainable or obtained by the reaction of at least one isocyanate monomer, at least one polyol selected from the group consisting of a polyester polyol, a polyether polyol and the combination thereof.

Suitable examples of isocyanate monomers are as described above in the “Isocyanate compound” portion.

Suitable examples of polyester polyols are as described above in the “Polyol Component” portion.

Polyether polyols can be the polyaddition products of ethylene oxide, propylene oxide, tetrahydrofuran, butylene oxide, and the co-addition and grafted products thereof, as well as the polyether polyols obtained by condensation of polyhydric alcohols, or mixtures thereof.

Examples of polyether polyols can include, but are not limited to, polypropylene glycol (“PPG”), polyethylene glycol (“PEG”), polybutylene glycol, and polytetramethylene ether glycol (“PTMEG”).

In an embodiment of the present disclosure, the polyether polyol can have a molecular weight within the numerical range obtained by combining any two of the following end points: 120, 200, 500, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol.

In some embodiments, the isocyanate component does not comprise a polyether polyol.

Compounds having isocyanate groups, such as the isocyanate prepolymer of the isocyanate component, may be characterized by the parameter “% NCO,” which is the amount of isocyanate groups by weight based on the weight of the compound. The parameter % NCO is measured by the method of ASTM D 2572-97(2010). The disclosed isocyanate component can have a % NCO of at least 3 wt %, or at least 5 wt %, or at least 7 wt %. In some embodiments, the isocyanate component can have a %NCO not to exceed 30 wt %, or 25 wt %, or 22 wt %, or 20 wt %.

The isocyanate component can, optionally, comprise one or more additional auxiliary agents and/or additives for specific purposes.

In some embodiments, the isocyanate component can, optionally, comprise one or more adhesion promoters to improve bond strength. Examples of the one or more adhesion promoters suitable for use in the isocyanate component include, but are not limited to, silane, epoxy and phenolic resin.

In further embodiments, the isocyanate component can, optionally, comprise one or more chain extenders. Examples of the one or more chain extenders suitable for use in the isocyanate component include, but are not limited to, glycerin, trimethylol propane, diethylene glycol, propanediol, and 2-methyl-1,3-propanediol.

In still further embodiments, the isocyanate component can, optionally, comprises one or more catalysts. Examples of the at least one catalyst suitable for use in the isocyanate component include, but are not limited to, dibutyltin dilaurate, zinc acetate, 2,2-dimorpholinodiethylether, and combinations thereof.

In some embodiments, the isocyanate component can further comprise one or more auxiliary agents and/or additives selected from the group consisting of other co-catalysts, surfactants, toughening agents, flow modifiers, diluents, stabilizers, plasticizers, catalyst de-activators, dispersing agents and mixtures thereof.

Application of the Adhesive Composition

In a further aspect, the present disclosure provides a cured adhesive composition.

In some embodiments, the cured adhesive composition can be prepared from the adhesive composition as described herein. In some embodiments, the cured adhesive composition can comprise the reaction product of a curable mixture of the polyol component and the isocyanate component as described herein. In some embodiments, the cured adhesive composition can be prepared by bringing the isocyanate component and the polyol component of the adhesive composition as described herein into contact to form a curable mixture, and curing the curable mixture. In some embodiments, the cured adhesive composition can be in the form of a layer. In some embodiments, the cured adhesive composition can be comprised in a laminate.

In a further aspect, the present disclosure provides a method of producing a cured laminate by using the adhesive composition as described herein.

In some embodiments, the method can comprise providing the adhesive composition comprising an isocyanate component and a polyol component as described. In some embodiments, each of the isocyanate component and the polyol component can be in a liquid, or a solid-liquid mixture.

In some embodiments, the method can comprise bringing the isocyanate component and the polyol component into contact, to form a curable mixture. In some embodiments, during the mixing, nitrogen is applied to avoid moisture contamination. In some embodiments, the moisture content of all raw materials is controlled below 500 ppm.

In some embodiments, the method can comprise applying the curable mixture on a first portion of a surface of a substrate (for example, a film) to form a layer of the curable mixture. As used herein, “the first portion of a surface of a substrate” can refer to a part of or the whole surface. In some embodiments, the first portion of a surface can be a part of the surface or the whole surface. In some embodiments, the dry coating weight of the curable mixture can be from 1.0 to 5.0 g/m², from 1.5 to 5.0 g/m², from 2.0 to 5.0 g/m², from 2.0 to 4.0 g/m², from 2.5 to 4.5 g/m², from 2.5 to 3.5 g/m², or from 3.0 to 4.0 g/m². In some embodiments, the substrate can be made of materials selected from the group consisting of polyethylenes, polypropylenes, polyesters, polyamides, metals, papers, cellophanes, and combinations thereof. In some embodiments, the substrate can be in the form of a film.

A “film” can refer to a layer of material having a thickness of 0.5 mm or less. In some embodiments, a film can be a structure that is 0.5 mm or less in one dimension and is 1 cm or more in both of the other two dimensions. In some embodiments, a polymer film is a film that is made of a polymer or mixture of polymers. In some embodiments, the thickness of the layer of the curable mixture applied to the film is 1 to 5 μm. Examples of films can include paper, woven and nonwoven fabric, metal foil, polymers, and metal-coated polymers. Films optionally have a surface on which an image is printed with ink; the ink may be in contact with the adhesive composition. In some embodiments, the films are polymer films and metal-coated polymer films, more preferred are polymer films.

In some embodiments, the method can comprise bringing a second portion of a surface of a substrate (for example, a film) into contact with the layer of the curable mixture, so that the layer of the curable mixture is sandwiched between the first portion and the second portion to form an uncured laminate. As used herein, “a second portion of a surface of a substrate” can refer to a part of or the whole surface. Generally, the second portion is different from the first portion as described above. In some embodiment, the first and second portions can be portions on the same or different surfaces. In some embodiments, the first and second portions can be portions of the same or different surfaces of the same or different substrates. In some embodiments, the first portion of a surface can be part of the surface or the whole surface. In some embodiments, the second portion of a surface can be part of the surface or the whole surface.

In some embodiments, the uncured laminate can be made at a time when the amount of unreacted polyisocyanate groups present in the adhesive composition is, on a molar basis compared to the amount of polyisocyanate groups present in the isocyanate component prior to contact with the polyol component, at least 50%, or at least 75%, or at least 90%. The uncured laminate can be further made at a time when the amount of unreacted polyisocyanate groups present in the curable mixture is less than 100%, or less than 97%, or less than 95%.

In some embodiments, the method can comprise evaporating the solvent or allowing it to evaporate.

In some embodiments, the method can comprise curing the curable mixture or allowing it to cure. In some embodiments, the uncured laminate may be cured at a suitable curing temperature of from 25° C. to 60° C. In some embodiments, the uncured laminate may be heated to speed the cure reaction. In some embodiments, the uncured laminate may be subjected to pressure, for example, by passing through nip rollers, which may or may not be heated.

In a further aspect, the present disclosure provides a cured laminate prepared by using the method as described above.

In a further aspect, the present disclosure provides a cured laminate, comprising a first portion of a surface of a substrate, a layer of a cured adhesive composition which is prepared from the adhesive composition as described herein, and a second portion of a surface of the same substrate or a different substrate, wherein the layer of the cured adhesive composition is sandwiched between and in contact with the first portion and the second portion.

In some embodiments, the substrate can be in the form of a film. In some embodiments, the cured laminate can be prepared by using the method of producing a cured laminate as described above.

In a further aspect, the present disclosure provides use of the phosphate functional isocyanate compound according to the present disclosure in a two-component polyurethane-based adhesive composition. In some embodiments, the adhesive composition can be solvent-based. In some embodiments, the phosphate functional isocyanate compound can be comprised in the isocyanate component of the adhesive composition.

### EXAMPLES

Some embodiments of the disclosure will now be described in the following Examples, wherein all parts and percentages are by weight unless otherwise specified. However, the scope of the present disclosure is not, of course, limited to the formulations set forth in these examples. Rather, the Examples are merely inventive of the disclosure.

1. Raw Materials

The information of the raw materials used in the examples is listed in the following Table 1.

TABLE 1
Raw Materials

| Raw Material | Description | Supplier |
|---|---|---|
| Desmodur 2460M | liquid MDI | Bayer |
| Mor-free 88-138 | Phosphate ester polyol, 100%, solid content | Dow |
| Adcote 545 | Current general performance solvent based | Dow |
| | adhesive polyester OH component, 66.7% | |
| | solid content | |
| 8302-3 | Polyester solution in ethyl acetate, 50% | Huide |
| | solid content | |
| Catalyst F | Toluene diisocyanate, oligomeric reaction | Dow |
| | products with 2,2′-oxydiethanol and | |
| | propylidenetrimethanol, 75% solid content, | |
| | ethyl acetate as solvent | |
| Ethyl Acetate | Solvent | SCRC |

2. Synthesis Procedure and Sample Preparation

Phosphate-functional isocyanate compounds of the Inventive Examples were synthesized according to the formulations listed in Table 2. Desmodur 2460M and Mor-free 88-138 were charged into a 1000 mL glass reactor and mixed carefully as the formulations shown in Table 2. After all raw materials were fed, heating was started. When temperature of the mixture of the raw materials reached around 60° C., the rotation speed was increased to 50 RM. Nitrogen was applied during the whole process to protect the system from moisture. When the reaction temperature reached around 80° C. to 85° C., cooling process was started and the reaction was kept at 80° C. to 85° C. for 2 hours. When the NCO value reached the theoretical value, the reactor was cooled as soon as possible. The system was cooled down to 60° C. to 70° C., ethyl acetate was charged into the glass reactor and the rotation speed was kept at 50 RM for 20 minutes. Then the final product was charged into a well-sealed steel bottle with nitrogen protection.

TABLE 2
Phosphate-functional isocyanate formulation

| Formulation | Desmodur 2460M | Mor-free 88-138 | Ethyl acetate |
|---|---|---|---|
| SR-F1 | 80 | 40 | 40 |
| SR-F2 | 150 | 11.25 | 3.75 |
| SR-F3 | 134 | 80 | 71 |

The NCO component and OH component used in the examples are as follows:
NCO-component: The phosphate-functional isocyanates SR-F1 (SR-F2 or SR-F3) and Dow current commercial co-reactant Catalyst F were chosen as the NCO component for trial.
OH-component: Dow's current GP solvent based lamination adhesive Adcote 545 and local vendor Huide's polyester solution in ethyl acetate 8302-3 were used as the OH-component.

The adhesive compositions of the Inventive Examples and Comparative Examples were prepared according to the formulations listed in table 3.

Before application, the NCO component and the OH component were mixed together. During the whole stirring process, nitrogen was applied to protect the system from moisture. Moisture content of all raw materials should be less than 500 ppm.

TABLE 3
Two-component solvent based adhesive formulations (by weight)

| | | |
|---|---|---|
| Adcote 545/SR-F1 | 100/11 | I-1 |
| Adcote 545/Catalyst F | 100/11 | C-1 |
| Adcote 545/SR-F2 | 100/15 | I-2 |
| Adcote 545/Catalyst F | 100/15 | C-2 |
| Adcote 545/SR-F3 | 100/11 | I-3 |
| 8302-3/SR-F1 | 100/9 | I-4 |
| 8302-3/Catalyst F | 100/9 | C-3 |
| 8302-3/SR-F2 | 100/11 | I-5 |
| 8302-3/Catalyst F | 100/11 | C-4 |
| 8302-3/SR-F3 | 100/9 | I-6 |

Coating and Laminating Process:

Coating and lamination process was conducted in SDC Labo-Combi 400 machine. The nip temperature was kept at 70° C. with 100 m/min speed during the whole lamination process. Dry coating weight was 3-3.5 g/m². Then the laminated film was cured at room temperature (23° C. to 25° C.) or in oven before testing for 1 week.

3. Test Methods:

T-peel (90°) Bonding Strength (Hand Assisted T-Peel) After curing, the laminated films were cut into 15 mm width strips for T-peel testing in Instron 5943 machine with 250 mm/min crosshead speed. Three strips were tested to take the average value. During the testing, the tail of the strip was pulled slightly by finger to make sure the tail remained 90° degree to the peeling direction

Heat Seal Strength:

The laminates were heat-sealed in a HSG-C Heat-Sealing Machine available from Brugger Company under 140° C. seal temperature and 300N pressure for 1 second, then cooled down and cut into 15 mm width strips for heat seal strength test under 250 mm/min crosshead speed using a 5940 Series Single Columnmn Table Top System available from Instron Corporation. Three strips for each sample were tested and the average value was calculated. Results were in the unit of N/15 mm.

Chemical Resistance (Boil-in-Bag packed with Morton Soup):

The cured laminating films were cut into 8×12″ size and then folded over to heat seal the bottom and side of the larger rectangle by heat seal machine under 140° C. and 300N/15 mm for 1 second. Then the pouch was filled with Morton soup with ⅔ full, before carefully sealing the top of the pouch in a manner that minimized the air entrapment. Morton soup can generally be described as a mixture of bean oil, ketchup, and vinegar with a 1:1:1 mixing ratio. The heat seal area was kept from being splashed by water, otherwise the heat seal would be poor. Any noticeable preexisting flaws in the heat seal area or laminating area was marked with an indelible marker. Then, the pouches were carefully placed in the boiling water and hold there for 30 min. Make sure the pouches were always immersed in water during the whole boiling process. When completed, the extent of tunneling, delamination, or leakage was recorded, in comparison with the pre-existing flaws. A sample that showed no evidence of tunneling, delamination, or leakage beyond any pre-existing heat seal or laminating flaws would be recorded as “pass”. Then the pouch was opened, emptied and allowed to cool down, then cut into 15 mm width strip to test the T-peel bonding strength and heat seal strength in Instron 5943 machine.

5. Performance Evaluation

The Bond Strength (BS), Heat Seal Strength (HS) and BIB properties are summarized in Table 4. The results show that the inclusion of the phosphate-functional isocyanate can significantly improve bonding strength to foil, chemical resistance (good heat seal without tunneling after boil-in-bag test with Morton soup), and hydrolysis stability of the two-component solvent based adhesives.

TABLE 4
Performance Results

| Performance Evaluation | | I-1 | C-1 | I-2 | C-2 | I-3 | I-4 | C-3 | I-5 | C-4 | I-6 |
|---|---|---|---|---|---|---|---|---|---|---|---|
| BS before BIB (N/15 MM) | Foil/PE | 13.55 | 3.4 | 6.45 | 2.3 | 4.97 | 10.28 | 2.32 | 5.32 | 3.69 | 4.32 |
| | Foil/RCPP | 8.82 | 3.2 | 5.44 | 2.18 | 5.75 | 7.1 | 2.11 | 4.32 | 2.89 | 4.56 |
| HS before BIB (N/15 MM) | Foil/PE | 45.56 | 38.98 | 45.55 | 35.75 | 43.21 | 44.86 | 32.78 | 42.33 | 47.89 | 43.22 |
| | Foil/RCPP | 52.9 | 35.42 | 47.88 | 33.09 | 45.33 | 53.57 | 26.66 | 41.22 | 49.89 | 40.98 |
| BS after BIB (N/15 MM) | Foil/PE | 14 | 2.45 | 5.78 | 2.01 | 5.04 | 10.21 | 1.89 | 4.68 | 3.32 | 5.21 |
| | Foil/RCPP | 7.42 | 1.89 | 4.32 | 1.58 | 4.89 | 6.21 | 2.01 | 4.02 | 1.191 | 3.98 |
| HS after BIB (N/15 MM) | Foil/PE | 50.09 | 24.53 | 42.22 | 23.44 | 40.44 | 44 | 20.12 | 40.09 | 34 | 40.22 |
| | Foil/RCPP | 48 | 22.33 | 40.9 | 22.11 | 43.85 | 46 | 18.22 | 38.77 | 32 | 44.22 |
| Appearance after BIB | Foil/PE | Good | Delamination | Good | Bubble | Good | Good | Delamination | Good | Bubble | Good |
| | Foil/RCPP | Good | Delamination | Good | Delamination | Good | Good | Delamination | Good | Delamination | Good |

What is claimed is:

1. An isocyanate compound containing a phosphate functional group, obtainable or obtained by the reaction of at least one selected from the group consisting of an isocyanate monomer, an isocyanate adduct and combinations thereof, with a phosphate functional polyol.

2. The isocyanate compound of claim 1, wherein the phosphate functional polyol has the structure represented by Formula (I): 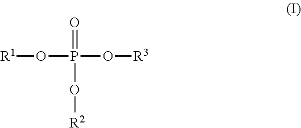
wherein each of R1, R² and R³ independently represents hydrogen or an organic group, with the proviso that at least one of R² and R³ represents an organic group, and R¹, R² and R³ altogether comprise at least two hydroxyl groups.

3. The isocyanate compound of claim 1, wherein the at least two hydroxyl groups comprised in R¹, R² and R³ are primary hydroxyl groups.

4. The isocyanate compound of claim 1, wherein one of R¹, R² and R³ represents an organic group and comprises at least two hydroxyl groups; alternatively two of R¹, R² and R³ represent each independently an organic group and comprise altogether at least two hydroxyl groups; alternatively, R² and R³ represent each independently an organic group and comprise altogether at least two hydroxyl groups.

5. The isocyanate compound of claim 1, wherein the isocyanate monomer or the isocyanate adduct comprises two or more isocyanate groups.

6. An adhesive composition, comprising:
(A) an isocyanate component comprising an isocyanate prepolymer which comprises the isocyanate compound of claim 1; and
(B) a polyol component comprising at least one polyester polyol.

7. The adhesive composition of claim 6, wherein the adhesive composition further comprises (C) a solvent.

8. The adhesive composition of claim 6, wherein the dry weight mix ratio of the polyol component to the isocyanate component is within the range of from 100:150 to 100:5.

9. The adhesive composition of claim 7, wherein the solvent is an organic solvent, and is preferably selected from the group consisting of methyl ethyl ketone, ethyl acetate, toluene and the combinations thereof.

10. A cured adhesive composition prepared from the adhesive composition of claim 6, comprising the reaction product of a curable mixture of the polyol component and the isocyanate component of the adhesive composition.

11. A method of producing a cured laminate by using the adhesive composition of claim 6, comprising
(a) providing the adhesive composition comprising an isocyanate component and a polyol component;
(b) bringing the isocyanate component and the polyol component into contact, to form a curable mixture;
(c) applying the curable mixture on a first portion of a surface of a substrate to form a layer of the curable mixture;
(d) bringing a second portion of a surface of the same substrate or a different substrate into contact with the layer of the curable mixture, so that the layer of the curable mixture is sandwiched between the first portion and the second portion;
(e) evaporating the solvent or allowing it to evaporate; and
(f) curing the curable mixture or allowing it to cure.

12. A cured laminate prepared by using the method of producing a cured laminate according to claim 11.

13. A cured laminate comprising a first portion of a surface of a substrate, a layer of a cured adhesive composition of claim 10, and a second portion of a surface of the same substrate or a different substrate, wherein the layer of the cured adhesive composition is sandwiched between and in contact with the first portion and the second portion.

14. Use of the isocyanate compound of claim 1 in a two-component solvent-based adhesive composition.
